(19) United States
(12) Patent Application Publication
(10) Pub. No.: US 2026/0285524 A1
(43) Pub. Date: Sep. 24, 2026

(54) A CONTAINER ROTATING UNIT AND A MACHINE FOR HANDLING CONTAINERS INCLUDING SUCH UNIT

(71) Applicant: Tirelli S.r.l., Marmirolo Mantova (IT)

(72) Inventors: Roberto TIRELLI, Marmirolo Mantova (IT); Daniele MAZZUCCO, Marmirolo Mantova (IT); Rangel RONCHI ANTERO, Marmirolo Mantova (IT); Denis CATTABRIGA, Marmirolo Mantova (IT)

(21) Appl. No.: 19/478,057

(22) PCT Filed: Apr. 17, 2024
(86) PCT No.: PCT/IB2024/053734

§ 371 Date: Oct. 23, 2025

(30) Foreign Application Priority Data
Apr. 26, 2023 (IT) 102023000008103

(51) Int. Cl. B65B 43/46; B65B 7/28; B65B 57/00; B65B 61/26; B65C 9/02; B65G 47/86

(52) U.S. Cl. CPC B65B 43/46; B65B 7/28; B65B 57/00; B65B 61/26; B65C 9/02; B65G 47/847; B65G 2201/0235

(57) ABSTRACT

A container rotating unit includes a base, a rotating body rotatable with respect to the base about a rotation axis and including a plate having a support surface for supporting containers, and a gripping device configured to grip a container resting on the support surface, wherein the gripping device includes a plurality of gripping elements movable between an open position and a gripping position, and wherein the gripping elements are axially movable with respect to the rotating body between a retracted position in which the gripping elements extend below the supporting surface and an extended position in which the gripping elements protrude above the support surface.

### FIELD OF THE INVENTION

The present invention refers in general to machines for handling containers.

More specifically, the invention relates to a container rotating unit.

The invention was developed with a view to its application, for example, to machines that carry out operations of inspection, orientation, closing, labelling, etc.

### DESCRIPTION OF THE PRIOR ART

In container handling machines, for example, in closing or labeling machines, when it is necessary to orientate the container around its vertical axis, the container is positioned on a plate that can rotate around a vertical axis by a motor or a cam mechanism.

When the bottom of the container is smooth, the base of the plate is also usually smooth and drags the container into rotation due to friction. In this case the support base is covered with rubber or other material which increases the coefficient of friction between the container and the support base. When the container has a notch on its bottom wall, the plate may have a projection that couples with the notch of the container to increase the torque that can be transmitted to the container.

To function correctly, machines with a rotating plate usually require a jack which engages the upper part of the container to stabilize the container and apply pressure from top to bottom to create the necessary force so that the necessary friction is generated between the plate and the container to rotate the container.

Machines for handling containers have already been proposed with a rotating plate provided with a gripping device configured for gripping the lower part of the container, so as to carry out a stable gripping of the container without the need for a jack that engages the upper part of the container.

EP-A-3025974 discloses a machine for handling containers having a support surface for a container and a plurality of levers for gripping a container positioned on the support surface. The levers are articulated to the support surface around respective vertical axes and are movable parallel to the support surface.

CN-A-103848381 discloses a plate having an upper rotating platform having a plurality of straight radial grooves, and a lower rotating platform having a plurality of spiral grooves. A plurality of gripping elements engage respective radial straight grooves and spiral grooves and are moved in a radial direction by the relative rotational movement between the upper rotating platform and the lower rotating platform.

DE-A-9419402 discloses a screwing device in which a container is held by clamps while a spindle screws a capsule onto the top of the container.

JP-A-2748545 discloses a device for gripping circular bodies such as capacitors or the like with different outer diameters. A rotating body has four gripping pins that are moved along respective radial slots and are retained by an expansion spring that is wrapped outside the gripping pins.

In known solutions, the gripping elements that grip the containers are located above the bases on which the containers rest and hinder the loading and unloading of the containers on the plates. The gripping devices of the containers according to the prior art are not compatible with the traditional container loading devices with star wheels that involve loading the containers onto the plates by sliding them along a plane aligned with the plane of the plates. Container gripping devices according to the prior art would therefore require more complex and expensive container loading/unloading systems.

### OBJECT AND SUMMARY OF THE INVENTION

The object of the present invention is to provide a container rotating unit that overcomes the problems of the prior art

According to the present invention, this object is achieved by a container rotating unit having the characteristics forming the subject of claim 1.

According to another aspect, the present invention relates to a machine for handling containers having the characteristics forming the subject of claim 9.

The claims form an integral part of the disclosure provided here in relation to the invention.

### BRIEF DESCRIPTION OF THE DRAWINGS

The present invention will now be described in detail with reference to the attached drawings, given purely by way of non-limiting example, wherein:

FIG. 1 is a perspective view of a container rotating unit according to the present invention,

FIG. 2 is cross-section of the container rotating unit according to the arrow II-II of FIG. 1,

FIGS. 3 and 4 are cross-sections similar to FIG. 2 showing the container rotating unit in other operating positions,

FIG. 5 is a perspective view of a machine for handling containers according to an embodiment of the present invention, and

FIG. 6 is a plan view of the machine for handling containers of FIG. 5.

It will be appreciated that the various figures may not be represented on the same scale. It will also be appreciated that some elements or components may not be illustrated to make other elements/components more visible and to simplify the understanding of the figures.

### DETAILED DESCRIPTION

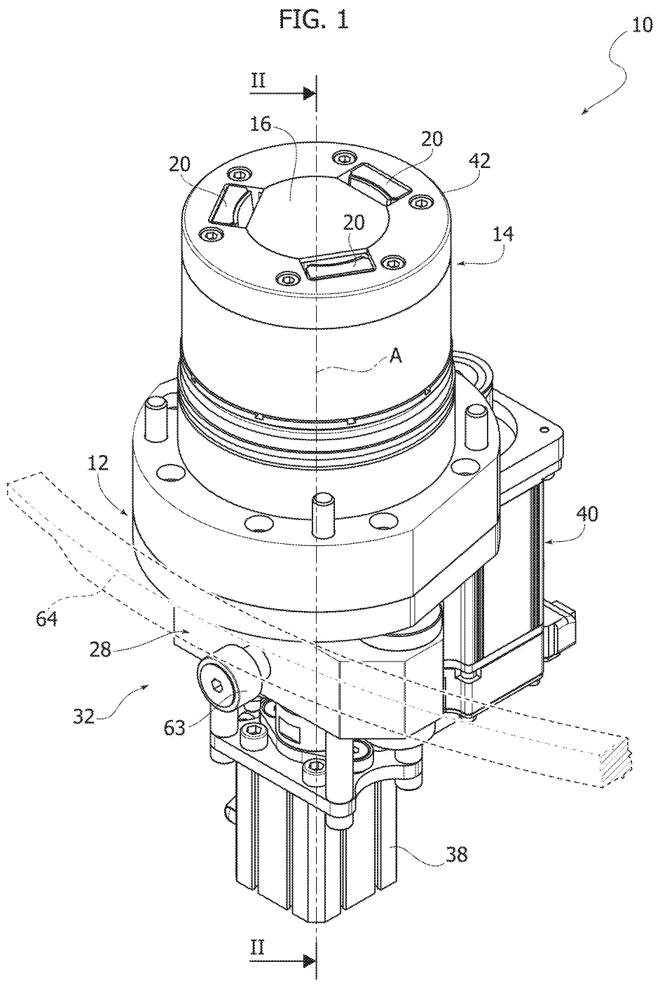

With reference to FIGS. 1-4, numeral 10 indicates a container rotating unit configured for rotating a container C around a vertical rotation axis A.

The container rotating unit 10 comprises a base 12 carrying a motor 40.

The base 12 carries a rotating body 14, rotatable with respect to the base 12 around the rotation axis A. The rotating body 14 includes a plate 42 having a support surface 16 for supporting containers C.

The rotating body 14 is driven in rotation around the rotation axis A by the motor 40, for example, by a belt transmission including a pulley 44 fixed with respect to the rotating body 14.

The container rotating unit 10 comprises a gripping device 18 configured to grip a container C placed on the support surface 16. The gripping device 18 comprises a plurality of gripping elements 20 (three in the example illustrated in the figures) movable between an open position and a gripping position.

The gripping elements 20 are axially movable with respect to the rotating body 14 in a direction parallel to the rotation axis A between a retracted position in which said gripping elements 20 extend below said support surface 16, and an extracted position in which said gripping elements 20 protrude above the support surface 16.

The gripping elements 20 are articulated to an articulation element 22 located underneath the plate 42. The articulation element 22 is rotationally fixed with respect to the rotating body 14 and is axially movable with respect to the rotating body 14 in the direction of the rotation axis A between a lowered position and a raised position.

Each of the gripping elements 20 is articulated to the articulation element 22 around a respective articulation axis B transverse to the rotation axis A.

The container rotating unit 10 comprises a first driving device 24 which controls the movement of the articulation element 22 in the direction of the rotation axis A between the lowered position and the raised position.

The first driving device 24 comprises a translating support 28 located below the rotating body 14. The translating support 28 is rotationally fixed with respect to the base 12 and is axially movable with respect to the base 12 in the direction of the rotation axis A between a lowered position and a raised position.

The first driving device 24 also comprises a sleeve 30 carried by the translating support 28. The sleeve 30 is axially fixed with respect to the translating support 28, and is rotatable with respect to the translating support 28 around the rotation axis A.

The articulation element 22 is fixed to an upper end of the sleeve 30, for example, by spacers 46 which keep the articulation element 22 at a certain distance from the upper end of the sleeve 30.

The translating support 28 may be associated with a cam mechanism 32 (FIG. 1), which controls the movement of the translating support 28 in the direction of the rotation axis A between the lowered position and the raised position. The cam mechanism 32 may comprise a cam-follower 63 fixed to the translating support 28 and cooperating with a cam 64.

The translating support 28 may be connected to the base 12 by vertical guide rods 66 parallel to the rotation axis A. The vertical guide rods 66 guide the movement of the translating support 28 in the direction of the rotation axis A, and prevent rotation of the translating support 28 around the rotation axis A. The vertical guide rods 66 may have respective upper ends fixed to the base 12 and may have respective heads 68 at their lower ends. Elastic elements 70, formed for example by helical springs in compression, may be arranged between the respective heads 68 of the vertical guide rods 66 and the translating support 28 to elastically push the translating support 28 towards its raised position. The cam 64 may be configured to push the translating support 28 towards its lowered position against the elastic force of the elastic elements 70.

The container rotating unit 10 comprises a second driving device 26 which controls the oscillation of the gripping elements 20 with respect to the articulation element 22 around the respective articulation axes B between the open position and the gripping position.

The second driving device 26 comprises a control member 34 connected to the gripping elements 20 by respective connecting rods 35. The control member 34 may be arranged between the upper end of the sleeve 30 and the articulation element 22.

The second driving device 26 comprises a stem 36 having an upper end fixed to the control member 34. The stem 36 extends coaxially to the rotation axis A inside the sleeve 30. The stem 36 is axially movable in the direction of the rotation axis A with respect to the sleeve 30.

The stem 36 has a lower end connected to a linear actuator 38 carried by the translating support 28. The stem 36 rotates around the rotation axis A together with the sleeve 30 and the rotating body 14, while the linear actuator 38 is fixed with respect to the translating support 28. The stem 36 is connected to the linear actuator 38 by a bearing 72, which serves to rotationally release the stem 36 from the linear actuator 38.

The operation of the container rotating unit 10 previously described is as follows.

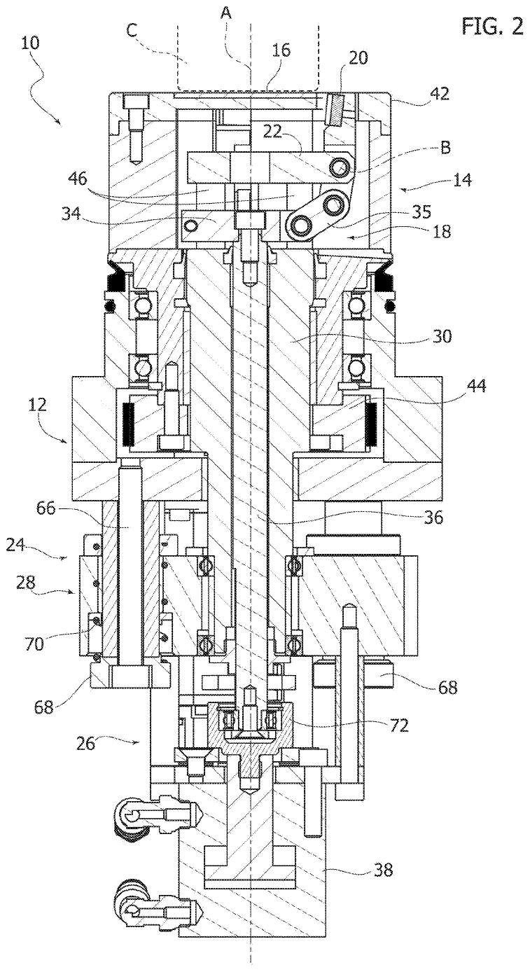

In the position illustrated in FIG. 2, the container rotating unit 10 is in the configuration for loading and unloading the containers C. In this configuration the translating support 28 is in the lowered position. Consequently, the articulation element 22—which is connected to the translating support 28 by the sleeve 30—is also in its lowered position and the gripping elements 20 are in their retracted position in which they extend below the support surface 16 of the plate 42. In this way, the support surface 16 the plate 42 is completely free and the containers C may be loaded onto the plate 42 or unloaded from the plate 42 by sliding them onto a plane coplanar to the support surface 16 of the plate 42.

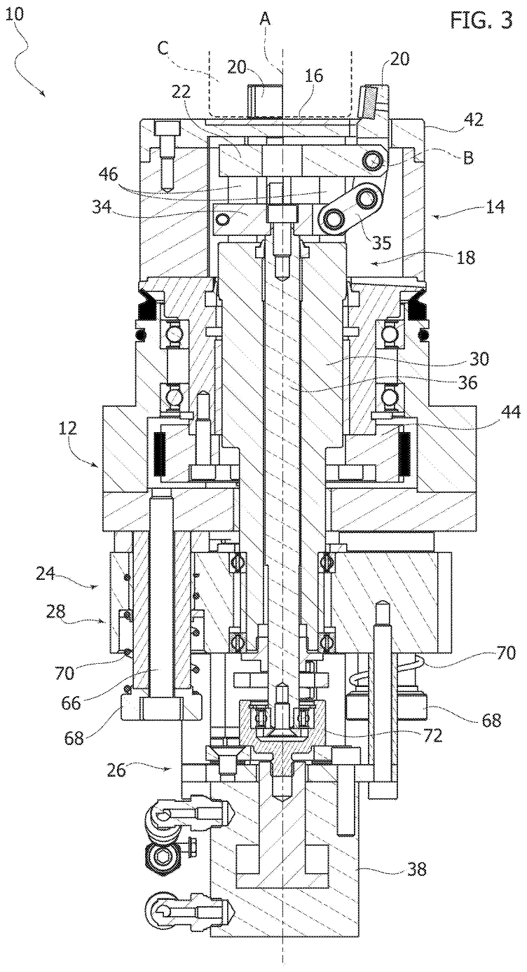

With reference to FIG. 3, after a container C has been placed on the support surface 16 of the plate 42, the translating support 28 is moved from the lowered position to the raised position. Consequently, the articulation element 22 also moves from the lowered position to the raised position. In this way, the gripping elements 20 move from the retracted position to the extracted position in which they protrude above the support surface 16. In this position the gripping elements 20 are located outside the bottom of the container C resting on the support surface 16 of the plate 42.

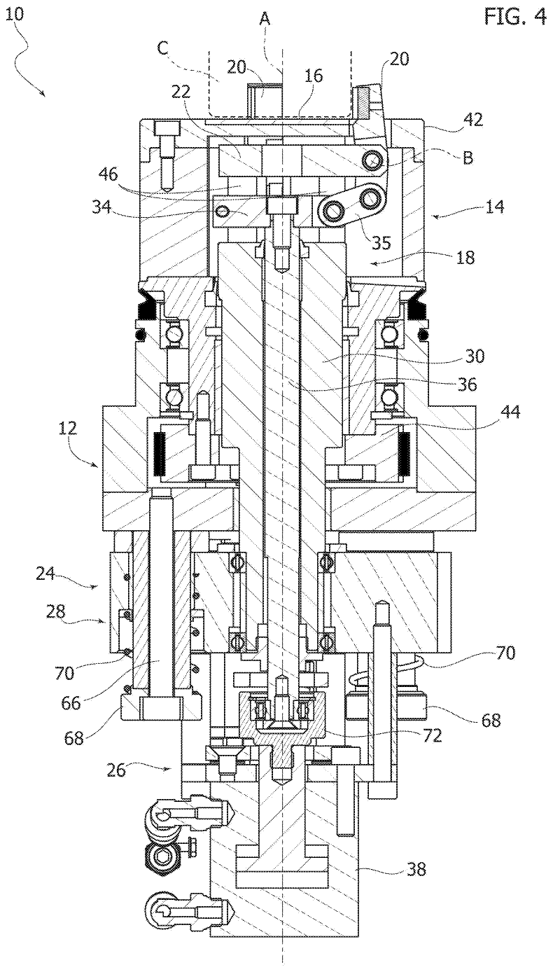

With reference to FIG. 4, after the gripping elements 20 have been moved to their extracted position, the linear actuator 38 is activated, which moves the stem 36 upwards along with the control member 34 fixed to the upper end of the stem 36. The upward movement of the control member 34 controls, via the connecting rods 35, the oscillation of the gripping elements 20 around the respective articulation axes B from the open position of FIG. 3 to the gripping position of FIG. 4.

In the gripping position, the gripping elements 20 grip the bottom of the container C and keep the container C anchored to the plate 42.

To unload a container C from the plate 42 the operations described above are repeated in reverse order: first the gripping elements 20 are moved from the gripping position to the open position by moving the stem 36 and the control member 34 downwards via the linear actuator 38, then the gripping elements 20 are moved from the extracted position to the retracted position by moving the translating support 28 from the raised position to the lowered position.

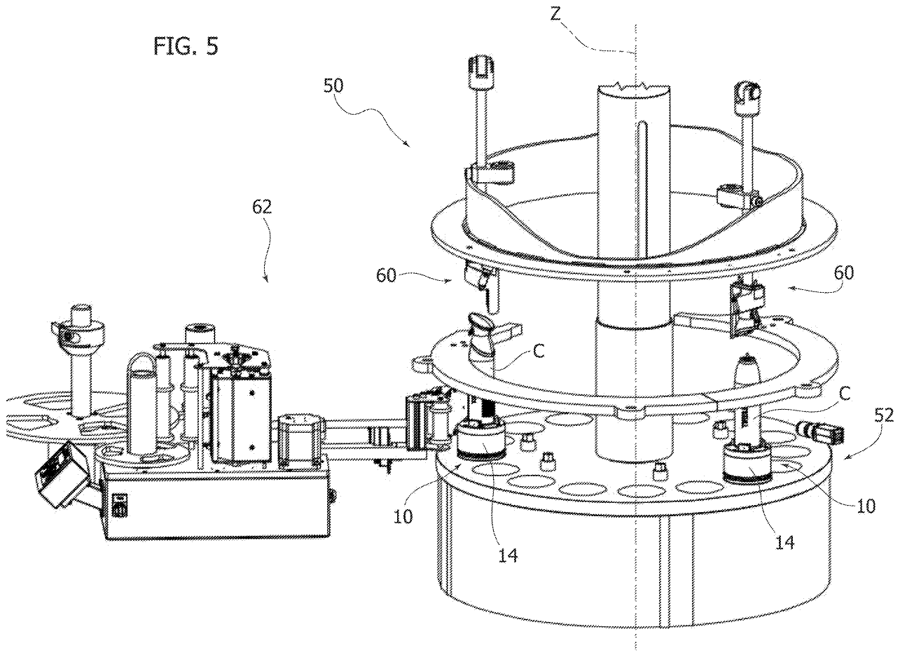

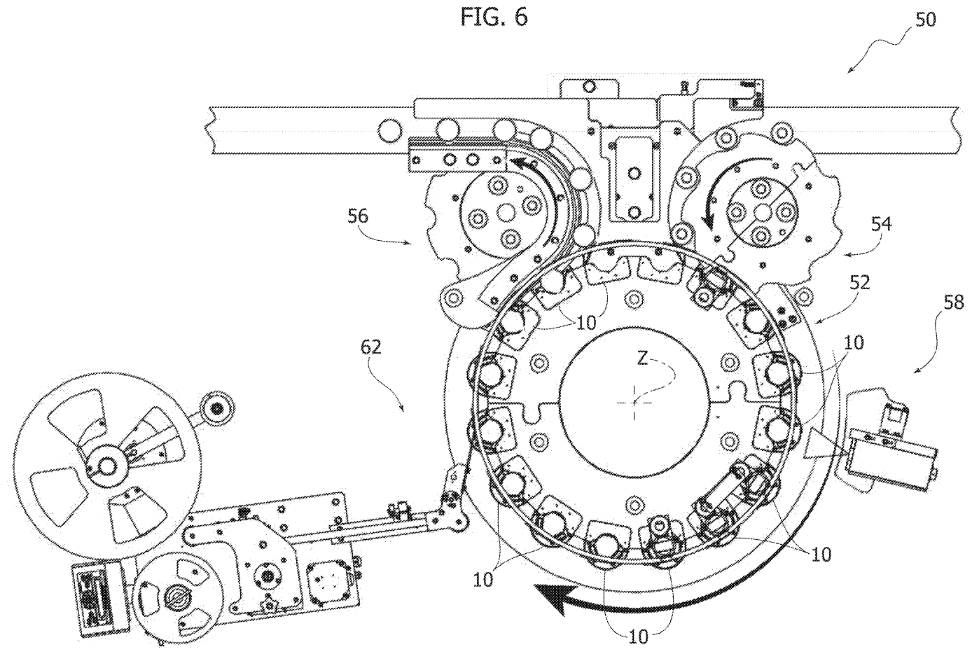

With reference to FIGS. 5 and 6, numeral 50 indicates a machine for handling containers comprising a carousel 52 rotatable around a vertical axis Z.

The carousel 52 carries a plurality of previously described container rotating units 10 angularly spaced apart from each other along the periphery of the carousel 52 and arranged with the respective rotation axes A parallel to the vertical axis Z of the carousel 52.

The carousel 52 comprises a loading station 54 for loading containers Conto respective plates 42, and an unloading station 56 for unloading containers C from respective plates 42. The loading station 54 and the unloading station 56 may be provided with respective star wheels for loading the containers C onto the carousel 52 and for unloading the containers C from the carousel 52.

The container rotating units 10 are controlled in phase with the rotation of the carousel 52 so that the gripping elements 20 are in the retracted position when the respective container rotating units 10 are located at the loading station 54 and the unloading station 56. In this way the containers C can be loaded onto the respective plates 42 or unloaded from the respective plates 42 by sliding them onto a horizontal plane without the gripping elements hindering the movement of the containers C. The gripping elements 20 are in the extracted and gripping position when the respective container rotating units 10 are located in the section between the loading station 54 and the unloading station 56.

The machine for handling containers 50 according to the present invention does not require jacks acting on the upper parts of the containers to keep the containers in a stable position on the plates during rotation.

Therefore, it is possible to carry out orientation, closing and labeling operations on the same machine.

FIG. 6 illustrates a machine for handling containers 50 which comprises:
an optical inspection station 58,
a plurality of closing heads 60 associated with respective container rotation units 10 and configured for applying closing members to respective containers C carried by the container rotation units 10, and
a labeling station 62 configured for applying labels to containers carried by said container rotation units 10.

Of course, without prejudice to the principle of the invention, the details of construction and the embodiments can be widely varied with respect to those described and illustrated, without thereby departing from the scope of the invention as defined by the claims that follow.

1. A container rotating unit comprising:
a base,
a rotating body rotatable with respect to the base about a rotation axis and including a plate having a support surface for supporting containers, and
a gripping device configured for gripping a container resting on said support surface wherein the gripping device comprises a plurality of gripping elements movable between an open position and a gripping position,
wherein said plurality of gripping elements are axially movable with respect to the rotating body in a direction parallel to said rotation axis between a retracted position in which said plurality of gripping elements extend below said support surface and an extracted position in which said plurality of gripping elements protrude above said support surface.

2. The container rotating unit of claim 1, wherein said plurality of gripping elements are articulated to an articulation element located below said support surface and wherein said articulation element is rotationally fixed with respect to the rotating body and is axially mobile with respect to the rotating body in the direction parallel to said rotation axis between a lowered position and a raised position.

3. The container rotating unit of claim 2, wherein each of said plurality of gripping elements is articulated to said articulation element around a respective articulation axis transverse with respect to said rotation axis.

4. The container rotating unit of claim 3, comprising a first driving device which controls the movement of said articulation element in the direction parallel to said rotation axis between said lowered position and said raised position, and a second driving device which controls the oscillation of said plurality of gripping elements with respect to the articulation element around the respective articulation axes between the open position and the gripping position.

5. The container rotating unit of claim 4, wherein the first driving device comprises:
a translating support rotationally fixed with respect to the base and axially movable with respect to the base in the direction parallel to said rotation axis between a support lowered position and a support raised position,
a sleeve carried by said translating support, wherein the sleeve is axially fixed with respect to the translating support and is rotatable with respect to the translating support about said rotation axis and wherein said articulation element is fixed to an upper end of said sleeve.

6. The container rotating unit of claim 5, wherein said translating support is associated with a cam mechanism which controls the movement of the translating support in the direction parallel of said rotation axis between said support lowered and support raised positions.

7. The container rotating unit of claim 5, wherein said second driving device comprises:
a control member connected to said plurality of gripping elements by respective connecting rods, and
a stem having an upper end fixed to said control member, wherein the stem extends coaxially to said rotation axis inside said sleeve, and wherein the stem is axially movable in the direction parallel to said rotation axis with respect to the sleeve.

8. The container rotating unit according to claim 7, wherein said stem has a lower end connected to a linear actuator carried by said translating support by a bearing.

9. A container handling machine comprising:
a carousel rotating around a vertical axis,
a plurality of container rotating units according to claim 1 carried by said carousel,
a loading station for loading containers onto respective container rotation units of the plurality of container rotating units,
an unloading station for unloading containers from the respective container rotation units,
wherein said plurality of gripping elements are in said retracted position when the respective container rotation units are at the loading station and the unloading station

10. The container handling machine of claim 9, comprising:
an optical inspection station
a plurality of closing heads associated with said respective container rotation units and configured for applying closing members to respective containers carried by said respective container rotation units, and
a labeling station configured for applying labels to the respective containers carried by said respective container rotation units.
